(19) United States
(12) Patent Application Publication
(10) Pub. No.: US 2026/0154532 A1
(43) Pub. Date: Jun. 4, 2026

(54) POWER GRAPH CONVOLUTIONAL NETWORK FOR EXPLAINABLE MACHINE LEARNING

(71) Applicant: EQUIFAX INC., Atlanta, GA (US)

(72) Inventors: Warren du Preez, Melbourne (AU); Bowen Huang, Melbourne (AU)

(21) Appl. No.: 18/698,679

(22) PCT Filed: Oct. 7, 2021
(86) PCT No.: PCT/US2021/071761

§ 371 Date: Apr. 4, 2024

(51) Int. Cl. G06N 3/0464; G06N 3/042; G06N 3/08

(52) U.S. Cl. CPC G06N 3/0464; G06N 3/042; G06N 3/08

(57) ABSTRACT

A power graph convolutional network (PGCN) can be used for explainable machine learning. For example, a computing device can determine, using a PGCN, a risk indicator for a target entity from predictor variables associated with the target entity. The PGCN includes a convolutional layer configured to generate modified predictor variables by multiplying each of the predictor variables with a respective interaction factor generated based on an adjacency weight matrix and the predictor variables. The PGCN also includes a dense layer configured to generate the risk indicator. The training process involves adjusting a set of weights in the adjacency weight matrix and a set of weights in a weight vector of the dense layer based on a loss function of the PGCN. The computing device transmits a responsive message including the risk indicator for use in controlling access of the target entity to one or more interactive computing environments.

### TECHNICAL FIELD

The present disclosure relates generally to machine learning and artificial intelligence. More specifically, but not by way of limitation, this disclosure relates to machine learning using a power graph convolutional network for emulating intelligence and that is trained for assessing risks or performing other operations and for providing explainable outcomes associated with these outputs.

### BACKGROUND

In machine learning, various models (e.g., artificial neural networks) have been used to perform functions such as providing a prediction of an outcome based on input values. These models can provide predictions with high accuracy because of their intricate structures, such as the interconnected nodes in a neural network. However, this also renders these machine learning models black-box models where the output of the model cannot be explained or interpreted. In other words, it is hard to explain why these models generate the specific results from the input values. As a result, it is hard, if not impossible, to justify, track or verify the results and to improve the model based on the results.

### SUMMARY

Various aspects of the present disclosure provide systems and methods for generating an explainable machine learning model based on a power graph convolutional network (PGCN) for risk assessment and outcome prediction. In one example, a method includes determining, using a power graph convolutional network trained by a training process, a risk indicator for a target entity from predictor variables associated with the target entity. The power graph convolutional network comprises (a) a convolutional layer configured to apply an adjacency weight matrix on the predictor variables to generate modified predictor variables and (b) a dense layer configured to apply a weight vector on the modified predictor variables to generate the risk indicator. The training process comprises adjusting a first set of weights in the adjacency weight matrix and a second set of weights in the weight vector based on a loss function of the power graph convolutional network and under an explainability constraint on the first set of weights or the second set of weights of the power graph convolutional network. The method further includes transmitting, to a remote computing device, a responsive message including at least the risk indicator for use in controlling access of the target entity to one or more interactive computing environments.

In another example, a system includes a processing device and a memory device in which instructions executable by the processing device are stored for causing the processing device to perform operations. The operations include determining, using a power graph convolutional network trained by a training process, a risk indicator for a target entity from predictor variables associated with the target entity. The power graph convolutional network comprises (a) a convolutional layer configured to apply an adjacency weight matrix on the predictor variables to generate modified predictor variables and (b) a dense layer configured to apply a weight vector on the modified predictor variables to generate the risk indicator. The training process comprises adjusting a first set of weights in the adjacency weight matrix and a second set of weights in the weight vector based on a loss function of the power graph convolutional network and under an explainability constraint on the first set of weights or the second set of weights of the power graph convolutional network. The operations further include transmitting, to a remote computing device, a responsive message including at least the risk indicator for use in controlling access of the target entity to one or more interactive computing environments.

In yet another example, a non-transitory computer-readable storage medium has program code that is executable by a processor device to cause a computing device to perform operations. The operations includes determining, using a power graph convolutional network trained by a training process, a risk indicator for a target entity from predictor variables associated with the target entity. The power graph convolutional network comprises (a) a convolutional layer configured to apply an adjacency weight matrix on the predictor variables to generate modified predictor variables and (b) a dense layer configured to apply a weight vector on the modified predictor variables to generate the risk indicator. The training process comprises adjusting a first set of weights in the adjacency weight matrix and a second set of weights in the weight vector based on a loss function of the power graph convolutional network and under an explainability constraint on the first set of weights or the second set of weights of the power graph convolutional network. The operations further include transmitting, to a remote computing device, a responsive message including at least the risk indicator for use in controlling access of the target entity to one or more interactive computing environments.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of a computing environment in which a power graph convolutional network can be trained and applied in a risk assessment application according to certain aspects of the present disclosure.

FIG. 2 is a flow chart depicting an example of a process for utilizing a power graph convolutional network to generate risk indicators for a target entity based on predictor variables associated with the target entity according to certain aspects of the present disclosure.

FIG. 3 is a diagram depicting an example of the architecture of a power graph convolutional network that can be generated and optimized according to certain aspects of the present disclosure.

FIG. 4 shows an example of the adjacency weight matrix of the power graph convolutional network, according to certain aspects of the present disclosure.

FIG. 5 shows examples of the adjacency weight matrix under different positivity constraints, according to certain aspects of the present disclosure.

FIG. 6 shows examples of the global significance and the local significance of the predictor variables determined using the parameters of the power graph convolutional network in comparison with prior art post-hoc algorithm, according to certain aspects of the present disclosure.

FIG. 7 is a block diagram depicting an example of a computing system suitable for implementing aspects of a power graph convolutional network according to certain aspects of the present disclosure.

### DETAILED DESCRIPTION

Certain aspects described herein are provided for generating an explainable machine learning model based on a power graph convolutional network (PGCN) for risk assessment and outcome prediction. A risk assessment computing system, in response to receiving a risk assessment query for a target entity, can access a power graph convolutional network trained to generate a risk indicator for the target entity based on input predictor variables associated with the target entity. The risk assessment computing system can apply the power graph convolutional network on the input predictor variables to compute the risk indicator. The risk assessment computing system may also generate explanatory data using parameters of the power graph convolutional network to indicate the impact of the predictor variables on the risk indicator. The risk assessment computing system can transmit a response to the risk assessment query for use by a remote computing system in controlling access of the target entity to one or more interactive computing environments. The response can include the risk indicator and the explanatory data.

For example, the power graph convolutional network can include a convolutional layer and a dense layer. The convolutional layer can be configured to take predictor variables (also referred to as “features”) as input and apply an adjacency weight matrix on the predictor variables. The adjacency weight matrix can reflect the interaction among the predictor variables and applying the adjacency weight matrix on the predictor variables can have the effect of imposing the influences of other predictor variables onto each predictor variable.

In some implementations, applying the adjacency weight matrix on the predictor variables can include multiple convolutions. In each convolution, the adjacency weight matrix can be multiplied with the predictor variables to generate an interaction vector. Each value in the interaction vector (also referred to as “interaction factor”) can correspond to one predictor variable. Each predictor variable can be updated by multiplying the predictor variable with a function of the corresponding interaction factor. The multiplication can ensure that a zero-valued predictor variable remains zero after the convolution. In addition, the adjacency weight matrix can be configured such that each interaction factor does not have a contribution from the corresponding predictor variable. For example, the diagonal values of the adjacency weight matrix can be set to zero so that when applying the adjacency weight matrix to the predictor variables, each predictor variable does not contribute to the generated corresponding interaction factor for itself. The updated predictor variables from one convolution can be used as input predictor variables for the next convolution. The output predictor variables of the convolutional layer (also referred to as “modified predictor variables”) can be used as input to the dense layer.

The dense layer can be configured to apply a weight vector to the modified predictor variables to generate the risk indicator. The weight vector can include a weight value for each predictor variable. The risk indicator can be generated based on the weighted combination of the modified predictor variables according to the weight vector.

The training of the power graph convolutional network can involve adjusting the parameters of the power graph convolutional network based on training predictor variables and risk indicator labels. The adjustable parameters of the power graph convolutional network can include the weights in the adjacency weight matrix and the weights in the weight vector of the dense layer. The parameters can be adjusted to optimize a loss function determined based on the risk indicators generated by the power graph convolutional network from the training predictor variables and the risk indicator labels.

In some aspects, the adjustment of the model parameters during the training can be performed under one or more explainability constraints. For instance, a symmetry constraint can be imposed to require the adjacency weight matrix to be a symmetric matrix. The symmetry constraint can be used to enforce that the influence a first predictor variable receives from a second predictor variable through applying the adjacency weight matrix is the same as the influence the first predictor variable imposes on the second predictor variable.

The training can also include a positivity constraint. In some examples, the positivity constraint can constrain the adjacency weight matrix and the weight vector such that training predictor variables that are positively correlated with the risk indicator labels correspond to positive weights in the weight vector of the dense layer (i.e. the interactions within this set of predictor variables are all positive) and training predictor variables that are negatively correlated with the risk indicator labels correspond to negative weights in the weight vector of the dense layer. The positivity constraints can further require those elements in the adjacency weight matrix that indicate interactions between these two sets of “positive” and “negative” predictor variables are also constrained to be negative. Alternatively, or additionally, the positivity constraint can require the off-diagonal elements of the adjacency weight matrix and the weight vector of the dense layer to be positive. This positivity constraint is also referred to as a “global positivity constraint.” To enforce the global positivity constraint, the risk assessment computing system can pre-process or prepare the training predictor variables so that the predictor variables have a positive correlation with the risk indicator labels in the training samples.

In some aspects, the trained power graph convolutional network can be used to predict risk indicators. For example, a risk assessment query for a target entity can be received from a remote computing device. In response to the assessment query, an output risk indicator for the target entity can be computed by applying the neural network to predictor variables associated with the target entity. Further, explanatory data indicating relationships between the risk indicator and the input predictor variables can also be calculated using the parameters of the power graph convolutional network, such as the weight values in the weight vector of the dense layer. A responsive message including at least the output risk indicator can be transmitted to the remote computing device.

Certain aspects described herein, which can include operations and data structures with respect to the power graph convolutional network, can provide an explainable machine learning model thereby overcoming the issues associated with black-box models identified above. For instance, the power graph convolutional network can be structured so that pair-wise inter-feature interactions among the input predictor variables are encoded in a way that is intuitively intelligible when generating the output risk indicator. The intelligibility can be achieved by imposing inter-feature interactions on a predictor variable through a multiplication of the predictor variable with an interaction factor generated based on the adjacency weight matrix and the remaining predictor variables. In addition, the interaction factor for each predictor variable can be generated through a power function which limits the impact of other predictor variables on each predictor variable within a certain range. Further, by imposing constraints on the parameters of the model, such as the symmetry constraint and the positivity constraint, the impact of other predictor variables on a predictor variable and the impact of the predictor variables on the final output can be controlled to have the same direction thereby making the output explainable. Compared with other existing explainable models, such as the logistic regression model, the power graph convolutional network can have a more complex model architecture and thus can generate a more accurate prediction. As a result, access control decisions or other types of decisions made based on the predictions generated by the power graph convolutional network are more accurate. Further, the interpretability of the power graph convolutional network makes these decisions explainable and allows entities to improve their respective predictor variables or features thereby obtaining desired access control decisions or other decisions.

In addition, the power graph convolutional network can allow explanatory data to be generated without applying additional techniques or algorithms, such as post-hoc techniques used to measure the impact of the input predictor variables on the output risk indicator. The parameters of the power graph convolutional network, such as the weight values in the weight vector of the dense layer can indicate the global significance of the predictor variables on the output risk indicator. The data generated by the power graph convolutional network when generating the output risk indicator can indicate the local significance of the predictor variables. As a result, the explanatory data can be generated with a much lower computational complexity than existing machine learning models where post-hoc algorithms are used, thereby allowing the prediction and explanatory data to be generated in real-time.

Additional or alternative aspects can implement or apply rules of a particular type that improve existing technological processes involving machine-learning techniques. For instance, to enforce the interpretability of the network, a particular set of rules can be employed in the training of the network. For example, the rules related to the symmetry constraint, positivity constraints can be implemented so that the impact of other predictor variables on a predictor variable and the impact of the predictor variables on the final output can be controlled to have the same direction. The rules related to imposing the influence of other predictor variables through multiplication rather than addition can allow for an interpretation of elements of the adjacency matrix as providing an intuitively plausible measure of interactive strength. The rules related to using a power function in the calculation of the interaction factor help to control the influence among predictor variables to be within a controlled range resulting in the trained network being easier to interpret directly and potentially more stable.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Machine-Learning Operations

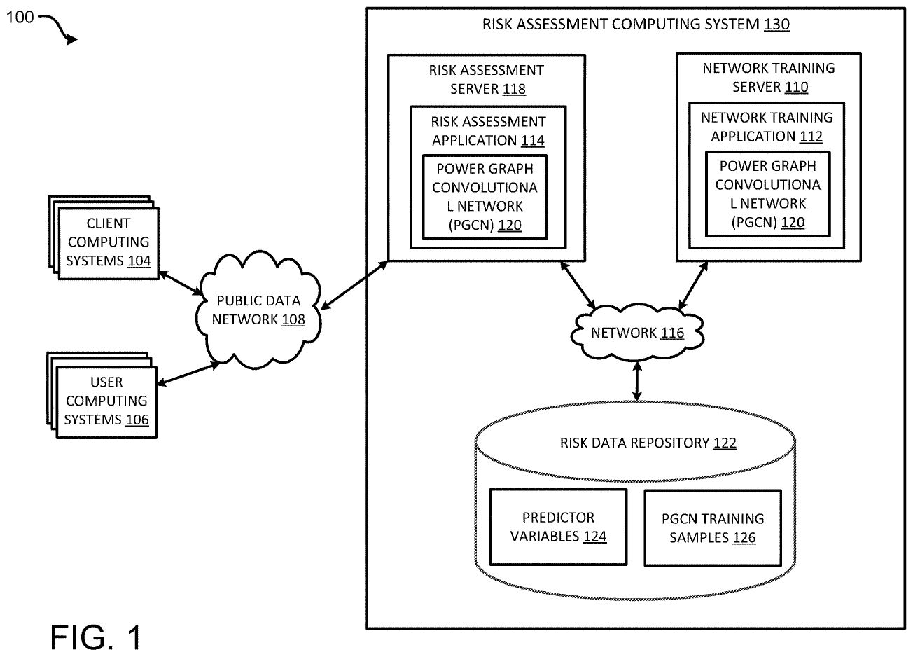

Referring now to the drawings, FIG. 1 is a block diagram depicting an example of an operating environment 100 in which a risk assessment computing system 130 builds and trains a power graph convolutional network that can be utilized to predict risk indicators based on predictor variables. FIG. 1 depicts examples of hardware components of a risk assessment computing system 130, according to some aspects. The risk assessment computing system 130 can be a specialized computing system that may be used for processing large amounts of data using a large number of computer processing cycles. The risk assessment computing system 130 can include a network training server 110 for building and training a power graph convolutional network 120 (or PGCN 120 in short) wherein the PGCN 120 can include a convolutional layer and a dense layer. The risk assessment computing system 130 can further include a risk assessment server 118 for performing a risk assessment for given predictor variables 124 using the trained PGCN 120.

The network training server 110 can include one or more processing devices that execute program code, such as a network training application 112. The program code can be stored on a non-transitory computer-readable medium. The network training application 112 can execute one or more processes to train and optimize a neural network for predicting risk indicators based on predictor variables 124.

In some aspects, the network training application 112 can build and train a PGCN 120 utilizing PGCN training samples 126. The PGCN training samples 126 can include multiple training vectors consisting of training predictor variables and training risk indicator outputs corresponding to the training vectors. The PGCN training samples 126 can be stored in one or more network-attached storage units on which various repositories, databases, or other structures are stored. Examples of these data structures are the risk data repository 122.

Network-attached storage units may store a variety of different types of data organized in a variety of different ways and from a variety of different sources. For example, the network-attached storage unit may include storage other than primary storage located within the network training server 110 that is directly accessible by processors located therein. In some aspects, the network-attached storage unit may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory, or memory devices.

The risk assessment server 118 can include one or more processing devices that execute program code, such as a risk assessment application 114. The program code can be stored on a non-transitory computer-readable medium. The risk assessment application 114 can execute one or more processes to utilize the PGCN 120 trained by the network training application 112 to predict risk indicators based on input predictor variables 124. In addition, the PGCN 120 can also be utilized to generate explanatory data for the predictor variables, which can indicate an effect or an amount of impact that one or more predictor variables have on the risk indicator.

The output of the trained PGCN 120 can be utilized to modify a data structure in the memory or a data storage device. For example, the predicted risk indicator and/or the explanatory data can be utilized to reorganize, flag, or otherwise change the predictor variables 124 involved in the prediction by the PGCN 120. For instance, predictor variables 124 stored in the risk data repository 122 can be attached with flags indicating their respective amount of impact on the risk indicator. Different flags can be utilized for different predictor variables 124 to indicate different levels of impact. Additionally, or alternatively, the locations of the predictor variables 124 in the storage, such as the risk data repository 122, can be changed so that the predictor variables 124 or groups of predictor variables 124 are ordered, ascendingly or descendingly, according to their respective amounts of impact on the risk indicator.

By modifying the predictor variables 124 in this way, a more coherent data structure can be established which enables the data to be searched more easily. In addition, further analysis of the PGCN 120 and the outputs of the PGCN 120 can be performed more efficiently. For instance, predictor variables 124 having the most impact on the risk indicator can be retrieved and identified more quickly based on the flags and/or their locations in the risk data repository 122. Further, updating the PGCN, such as re-training the PGCN based on new values of the predictor variables 124, can be performed more efficiently especially when computing resources are limited. For example, updating or retraining the PGCN can be performed by incorporating new values of the predictor variables 124 having the most impact on the output risk indicator based on the attached flags without utilizing new values of all the predictor variables 124.

Furthermore, the risk assessment computing system 130 can communicate with various other computing systems, such as client computing systems 104. For example, client computing systems 104 may send risk assessment queries to the risk assessment server 118 for risk assessment, or may send signals to the risk assessment server 118 that control or otherwise influence different aspects of the risk assessment computing system 130. The client computing systems 104 may also interact with user computing systems 106 via one or more public data networks 108 to facilitate interactions between users of the user computing systems 106 and interactive computing environments provided by the client computing systems 104.

Each client computing system 104 may include one or more third-party devices, such as individual servers or groups of servers operating in a distributed manner. A client computing system 104 can include any computing device or group of computing devices operated by a seller, lender, or other providers of products or services. The client computing system 104 can include one or more server devices. The one or more server devices can include or can otherwise access one or more non-transitory computer-readable media. The client computing system 104 can also execute instructions that provide an interactive computing environment accessible to user computing systems 106. Examples of the interactive computing environment include a mobile application specific to a particular client computing system 104, a web-based application accessible via a mobile device, etc. The executable instructions are stored in one or more non-transitory computer-readable media.

The client computing system 104 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system 106 to access various functions of the interactive computing environment. For instance, the interactive computing environment may transmit data to and receive data from a user computing system 106 to shift between different states of the interactive computing environment, where the different states allow one or more electronics transactions between the user computing system 106 and the client computing system 104 to be performed.

In some examples, a client computing system 104 may have other computing resources associated therewith (not shown in FIG. 1), such as server computers hosting and managing virtual machine instances for providing cloud computing services, server computers hosting and managing online storage resources for users, server computers for providing database services, and others. The interaction between the user computing system 106 and the client computing system 104 may be performed through graphical user interfaces presented by the client computing system 104 to the user computing system 106, or through an application programming interface (API) calls or web service calls.

A user computing system 106 can include any computing device or other communication device operated by a user, such as a consumer or a customer. The user computing system 106 can include one or more computing devices, such as laptops, smartphones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 104 or other computing resources, to engage in mobile commerce with a client computing system 104, to obtain controlled access to electronic content hosted by the client computing system 104, etc.

For instance, the user can use the user computing system 106 to engage in an electronic transaction with a client computing system 104 via an interactive computing environment. An electronic transaction between the user computing system 106 and the client computing system 104 can include, for example, the user computing system 106 being used to request online storage resources managed by the client computing system 104, acquire cloud computing resources (e.g., virtual machine instances), and so on. An electronic transaction between the user computing system 106 and the client computing system 104 can also include, for example, query a set of sensitive or other controlled data, access online financial services provided via the interactive computing environment, submit an online credit card application or other digital application to the client computing system 104 via the interactive computing environment, operating an electronic tool within an interactive computing environment hosted by the client computing system (e.g., a content-modification feature, an application-processing feature, etc.).

In some aspects, an interactive computing environment implemented through a client computing system 104 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 106 can be used to request access to the interactive computing environment provided by the client computing system 104, which can selectively grant or deny access to various electronic functions. Based on the request, the client computing system 104 can collect data associated with the user and communicate with the risk assessment server 118 for risk assessment. Based on the risk indicator predicted by the risk assessment server 118, the client computing system 104 can determine whether to grant the access request of the user computing system 106 to certain features of the interactive computing environment.

In a simplified example, the system depicted in FIG. 1 can configure a power graph convolutional network to be used both for accurately determining risk indicators, such as credit scores, using predictor variables and determining explanatory data for the predictor variables. A predictor variable can be any variable predictive of risk that is associated with an entity. Any suitable predictor variable that is authorized for use by an appropriate legal or regulatory framework may be used.

Examples of predictor variables used for predicting the risk associated with an entity accessing online resources include, but are not limited to, variables indicating the demographic characteristics of the entity (e.g., name of the entity, the network or physical address of the company, the identification of the company, the revenue of the company), variables indicative of prior actions or transactions involving the entity (e.g., past requests of online resources submitted by the entity, the amount of online resource currently held by the entity, and so on), variables indicative of one or more behavioral traits of an entity (e.g., the timeliness of the entity releasing the online resources), etc. Similarly, examples of predictor variables used for predicting the risk associated with an entity accessing services provided by a financial institute include, but are not limited to, indicative of one or more demographic characteristics of an entity (e.g., age, gender, income, etc.), variables indicative of prior actions or transactions involving the entity (e.g., information that can be obtained from credit files or records, financial records, consumer records, or other data about the activities or characteristics of the entity), variables indicative of one or more behavioral traits of an entity, etc.

The predicted risk indicator can be utilized by the service provider to determine the risk associated with the entity accessing a service provided by the service provider, thereby granting or denying access by the entity to an interactive computing environment implementing the service. For example, if the service provider determines that the predicted risk indicator is lower than a threshold risk indicator value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 associated with the service provider can also allocate resources to the user and provide a dedicated web address for the allocated resources to the user computing system 106, for example, by adding it in the access permission. With the obtained access credentials and/or the dedicated web address, the user computing system 106 can establish a secure network connection to the computing environment hosted by the client computing system 104 and access the resources via invoking API calls, web service calls, HTTP requests, or other proper mechanisms.

Each communication within the operating environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the network training server 110 and the risk assessment server 118, may be instead implemented in a signal device or system.

### Examples of Operations Involving Machine-Learning

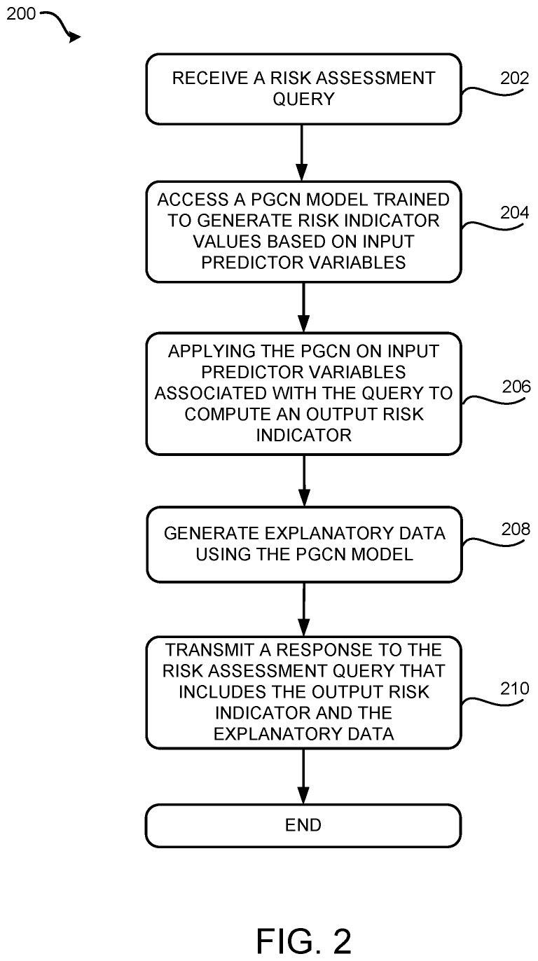

FIG. 2 is a flow chart depicting an example of a process 200 for utilizing a power graph convolutional network to generate risk indicators for a target entity based on predictor variables associated with the target entity. One or more computing devices (e.g., the risk assessment server 118) implement operations depicted in FIG. 2 by executing suitable program code (e.g., the risk assessment application 114). For illustrative purposes, the process 200 is described with reference to certain examples depicted in the figures. Other implementations, however, are possible.

At block 202, the process 200 involves receiving a risk assessment query for a target entity from a remote computing device, such as a computing device associated with the target entity requesting the risk assessment. The risk assessment query can also be received by the risk assessment server 118 from a remote computing device associated with an entity authorized to request risk assessment of the target entity.

At operation 204, the process 200 involves accessing a PGCN model trained to generate risk indicator values based on input predictor variables or other data suitable for assessing risks associated with an entity. As described in more detail with respect to FIG. 1 above, examples of predictor variables can include data associated with an entity that describes prior actions or transactions involving the entity (e.g., information that can be obtained from credit files or records, financial records, consumer records, or other data about the activities or characteristics of the entity), behavioral traits of the entity, demographic traits of the entity, or any other traits that may be used to predict risks associated with the entity. In some aspects, predictor variables can be obtained from credit files, financial records, consumer records, etc. The risk indicator can indicate a level of risk associated with the entity, such as a credit score of the entity.

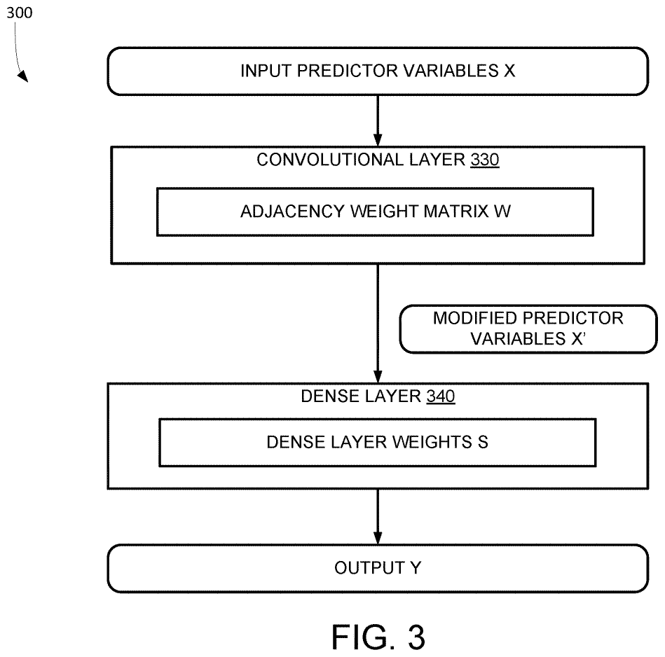

The PGCN can be constructed and trained based on training samples including training predictor variables and training risk indicator outputs (also referred to as “risk indicator labels”). An explainability constraint can be imposed on the training of the PGCN so that an adjacency weight matrix applied to the predictor variables by a convolutional layer is a symmetric matrix. A positivity constraint can also be imposed on the training of the PGCN. Additional details regarding training the neural network will be presented below with regard to FIGS. 3-5.

At operation 206, the process 200 involves applying the PGCN to generate a risk indicator for the target entity specified in the risk assessment query. Predictor variables associated with the target entity can be used as inputs to the PGCN. The predictor variables associated with the target entity can be obtained from a predictor variable database configured to store predictor variables associated with various entities. The output of the PGCN can include the risk indicator for the target entity based on its current predictor variables.

At operation 208, the process 200 involves generating explanatory data using the PGCN model. The explanatory data can indicate relationships between the risk indicator and at least some of the input predictor variables. The explanatory data may indicate an impact a predictor variable has or a group of predictor variables have on the value of the risk indicator, such as credit score (e.g., the relative impact of the predictor variable(s) on a risk indicator). The explanatory data can be calculated using the parameters of the PGCN. The parameters may be weight values in a weight vector of a dense layer of the PGCN. In some aspects, the risk assessment application uses the PGCN to provide explanatory data that are compliant with regulations, business policies, or other criteria used to generate risk evaluations. Examples of regulations to which the PGCN conforms and other legal requirements include the Equal Credit Opportunity Act (“ECOA”), Regulation B, and reporting requirements associated with ECOA, the Fair Credit Reporting Act (“FCRA”), the Dodd-Frank Act, and the Office of the Comptroller of the Currency (“OCC”).

In some implementations, the explanatory data can be generated for a subset of the predictor variables that have the highest impact on the risk indicator. For example, the risk assessment application 114 can determine the rank of each predictor variable based on the impact of the predictor variable on the risk indicator. A subset of the predictor variables including a certain number of highest-ranked predictor variables can be selected and explanatory data can be generated for the selected predictor variables.

At operation 210, the process 200 involves transmitting a response to the risk assessment query. The response can include the risk indicator generated using the PGCN and the explanatory data. The risk indicator can be used for one or more operations that involve performing an operation with respect to the target entity based on a predicted risk associated with the target entity. In one example, the risk indicator can be utilized to control access to one or more interactive computing environments by the target entity. As discussed above with regard to FIG. 1, the risk assessment computing system 130 can communicate with client computing systems 104, which may send risk assessment queries to the risk assessment server 118 to request risk assessment. The client computing systems 104 may be associated with technological providers, such as cloud computing providers, online storage providers, or financial institutions such as banks, credit unions, credit-card companies, insurance companies, or other types of organizations. The client computing systems 104 may be implemented to provide interactive computing environments for customers to access various services offered by these service providers. Customers can utilize user computing systems 106 to access the interactive computing environments thereby accessing the services provided by these providers.

For example, a customer can submit a request to access the interactive computing environment using a user computing system 106. Based on the request, the client computing system 104 can generate and submit a risk assessment query for the customer to the risk assessment server 118. The risk assessment query can include, for example, an identity of the customer and other information associated with the customer that can be utilized to generate predictor variables. The risk assessment server 118 can perform a risk assessment based on predictor variables generated for the customer and return the predicted risk indicator and explanatory data to the client computing system 104.

Based on the received risk indicator, the client computing system 104 can determine whether to grant the customer access to the interactive computing environment. If the client computing system 104 determines that the level of risk associated with the customer accessing the interactive computing environment and the associated technical or financial service is too high, the client computing system 104 can deny access by the customer to the interactive computing environment. Conversely, if the client computing system 104 determines that the level of risk associated with the customer is acceptable, the client computing system 104 can grant access to the interactive computing environment by the customer and the customer would be able to utilize the various services provided by the service providers. For example, with the granted access, the customer can utilize the user computing system 106 to access clouding computing resources, online storage resources, web pages or other user interfaces provided by the client computing system 104 to execute applications, store data, query data, submit an online digital application, operate electronic tools, or perform various other operations within the interactive computing environment hosted by the client computing system 104.

The risk assessment application 114 may provide recommendations to a target entity based on the generated explanatory data. The recommendations may indicate one or more actions that the target entity can take to improve the risk indicator (e.g., improve a credit score).

Referring now to FIG. 3, an example of the architecture of a PGCN 300 that can be generated and optimized according to certain aspects of the present disclosure is illustrated. The PGCN 300 is an example of the PGCN 120 in FIG. 1. The PGCN 300 can include a convolutional layer 330 and a dense layer 340. The convolutional layer 330 receives input predictor variables X, which are an example of predictor variables 124 in FIG. 1. The convolutional layer 330 can apply an adjacency weight matrix W on the predictor input variables X to generate an interaction vector. Each value in the interaction vector corresponds to one predictor variable. The adjacency weight matrix W reflects the interaction among the input predictor variables X and applying the adjacency weight matrix W on the input predictor variables X has the effect of imposing the influences of other predictor variables onto each predictor variable.

In general, to say of two predictor variables or features A and B that A interacts with B, is to say that there exists a counterfactual relation between A and B such that the effect of B on model output would have been different if A were not present. However, given that there is an interaction between A and B, there are at least three aspects of this interaction that can be assessed. The first aspect can be the “marginal interactive effect.” The marginal interactive effect of A on B can potentially be functionally defined as the difference between the effect of B where A is present on the one hand, and the effect of B where A is not present on the other hand. The second aspect can be the “total interactive effect,” which refers to the joint effect of A and B on model output. As an example, the total interactive effect may be described as “the total interactive effect of A and B led to a contribution of X.” The third aspect can be the “directionality” of an interaction relation. The directionality may be either positive or negative, meaning the features involved in a particular interaction will either work in the same direction, or in opposing directions. Importantly, directionality can be distinguished from marginal effect. For example, features A and B may both contribute in the same direction to model output, thus standing in an interaction relationship with positive directionality, but it may be that the marginal effects of A and B on each other are both negative such that the interaction is actually mutually deflating.

It will be seen that the interaction information that can be captured in the graph component of the PGCN 300 can allow for an understanding of both interaction directionality and relative marginal contribution. So the PGCN may be considered more interpretable or explainable than logistic regression insofar as this is the case. Given the accessibility of significance and interaction information, the architecture of PGCN in its constrained form can be explainable or interpretable.

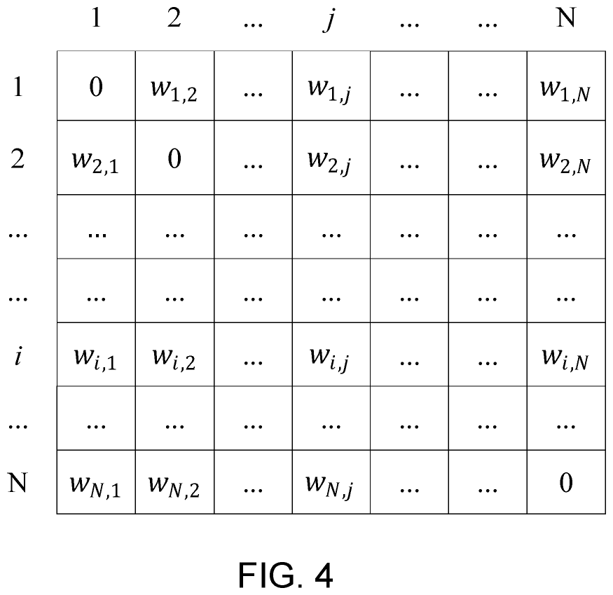

FIG. 4 shows an example of the adjacency weight matrix W of the power graph convolutional network, according to certain aspects of the present disclosure. Each of the rows and columns corresponds to one predictor variable. The adjacency weight matrix in FIG. 4 includes N predictor variables. The adjacency weight matrix can be configured such that each interaction factor does not have a contribution from the corresponding predictor variable. For example, the diagonal values of the adjacency weight matrix can be set to zero so that when applying the adjacency weight matrix to the predictor variables, each predictor variable does not contribute to the generated corresponding interaction factor for itself. The values of the adjacency weight matrix W may be determined during training and under one or more constraints, as described below.

Returning to FIG. 3, in a traditional graph convolutional network architecture, the input predictor variables X is a vector of dimension N. The following recursive operation can be performed:

$${S}_{1} = X + h σ ( W \cdot {X}^{T} )$$

$${S}_{2} = {S}_{1} + h σ ( W \cdot {S}_{1}^{T} )$$

$${S}_{r} = {S}_{r - 1} + h σ ( W \cdot {S}_{r - 1}^{T} )$$

where h is a hyperparameter that controls the general level of influence from one predictor variable to another, r is a hyperparameter that controls a number of convolutions performed, and Sᵣ is the output of the multiple convolutions.

At the convolutional layer 330, an input vector of the input predictor variables X of dimension N is propagated through the adjacency weight matrix W of degree N with zero diagonal, r times. After each propagation, the outputs are added to the original input vector, and this adjusted interaction vector can be used as the input for the next convolution. After a number of convolutions, the result is a vector of modified predictor variables X′ with the same size as the original input vector X, and due to the addition operation after each propagation, the meaning of the predictor variables of this vector remain tied to the original input vector predictor variables.

In this sense, given a particular ordering of the input features, the n^{th} input feature is associated with the n^{th} row vector of W (the n^{th} element of which is zero), because the sigmoid of the dot product of the input vector and this row vector is added recursively to the n^{th} input feature (and only that feature) through the convolution process. Given that the elements of each row vector of the adjacency weight matrix W indicate, for each input feature, “how much” of every other input feature is added to (i.e. influences) it at each convolution, these row vector elements can reasonably be interpreted as representing the interaction relationship holding between each feature and every other feature (each pair of features is uniquely represented by an element of W), and the sign attached to each of these values indicates interaction directionality. Furthermore, given that at every recursion the component that is added to each feature contains the interaction information that is introduced to that feature at that recursion, and given that the parameters comprising W do not change across recursions, the relative strength (i.e. relative marginal interactive effects) of a particular feature's interactive relationships in general (i.e. independently of any particular recursion) can be understood by assessing its associated row vector of W. Indeed, assessing the relative strength of interactions for a particular feature can be a matter of calculating the global interaction significance of features that enter into the α(W·Sᵣ₋₁^{T}) term, for a particular row vector.

To provide the intuition that the graph convolutional network layer is suitable for encoding inter-feature interactions, the graph convolutional network layer can be understood in terms of its graph visualization. Under a fully connected adjacency weight matrix, at each convolution, to every feature (node), some part of every other feature (node) is added—this can be interpreted directly as a situation where each feature has some influence on every other feature, and the level and direction of this influence are captured by the edges of the graph. Consider for example the following adjacency weight matrix, for a case of 3 input features:

$$( \begin{matrix}0 & 0.2 & 0.4 \\ 0.3 & 0 & 0.6 \\ - 0.5 & 0.1 & 0\end{matrix} )$$

Here, the interaction of feature 2 with feature 3 is quantified as 0.6, where this is the most significant interaction.

There may be problems with interpreting the output of the graph convolutional layer of the traditional graph convolutional network architecture. The first problem arises in light of the fact that it is likely that there are cases where some input feature has a value of zero, but where the corresponding element of the feature vector output from the graph convolutional network layer is non-zero. But, if a feature has no informational value (i.e. is it zero), the feature should have no local significance.

That said, it may be possible to solve this problem by deviating from the standard graph convolutional network algorithm, replacing the additive operation at each convolution with multiplication. The multiplication can ensure that a zero-valued predictor variable remains zero after the convolution. Additionally, the σ(W·Sᵣ₋₁^{T}) term can be replaced with pow(tan h(W·Sᵣ₋₁^{T}), n) where n can be a positive constant, pow(a, b)=b^{a}, and the * operator can indicate element-wise multiplication. The modified graph convolutional network is referred to herein as the power graph convolutional network (PGCN). The recursion equation for PGCN layers then becomes:

$${S}_{1} = X * p o w ( tanh ( W \cdot {X}^{T} ) , n )$$

$${S}_{2} = {S}_{1} * p o w ( tanh ( W \cdot {S}_{1}^{T} ) , n )$$

$$…$$

$${S}_{r} = {S}_{r - 1} * p o w ( tanh ( W \cdot {S}_{r - 1}^{T} ) , n )$$

If some input feature is zero, the element corresponding to this feature in the output vector of the PGCN layer will be zero. Then given tan h activation, the interaction term tan h(W·Sᵣ₋₁^{T}) will lie in the range [−1; 1], and when term W·Sᵣ₋₁^{T} is zero, tan h(0)=0. Each of the three cases corresponding to negative, positive, and zero exponents for n allow for a clear and suitable interpretation. In the negative case, the interaction term can act so as to deflate the original feature value, and the level of deflation that is possible will depend on the size of n. Likewise, in the positive case, the interaction term can act so as to inflate the original feature value by a factor of n. In the case of n⁰=1, the original feature is unaffected, which is desirable given that the interaction term is zero. Note that the parameter n can be used to control the general influence of interactions on model output. For example, if n is set to two, for example, this allows that in general the interactions associated with some feature can, in the extreme cases, either halve or double the original value of that feature at each convolution. For a case where r=2, the effect of interactions may in the end quarter or quadruple the original feature value in extreme cases. n and its exponent tan h(W·Sᵣ₋₁^{T}) can accordingly be clearly distinguished in terms of the way that they relate to interactions: n controls the impact that interactions can have in general on model output, and tan h(W·Sᵣ₋₁^{T}) controls the relative impact that interactions will have in the case of each feature. Note that the switch from GCN to PGCN has no effect on the reasonableness of interpreting the elements of the row vectors of the associated adjacency weight matrix as the relative strength of interactions. The feature-wise interaction information can be contained in the exponent of n, and as this is given by tan h(W·Sᵣ₋₁^{T}), the coefficients of each row of W are analogous to the coefficients of a logistic regression model representing the impact of interactions per feature, so these coefficients can be interpreted as indicating relative marginal interactive effects.

The modified predictor variables X′ generated by multiplying each of the predictor variables with a respective interaction factor generated based on the adjacency weight matrix W and the input predictor variables X are used as input to the dense layer 340. The dense layer 340 can apply dense layer weights S to the modified predictor variables X′ to generate the risk indicator, or output Y. The dense layer weights S can include a weight for each predictor variable. The values of the dense layer weights S may be determined during training and under one or more constraints, as described below. The risk indicator Y can be generated based on the weighted combination of the modified predictor variables X′ according to the dense layer weight vector S.

Training of the PGCN 300 can involve the network training application 112 adjusting the parameters of the PGCN 300 based on training predictor variables and risk indicator labels. The adjustable parameters of the PGCN 300 can include the weights in the adjacency weight matrix W and the dense layer weights S. The network training application 112 can adjust the weights to optimize a loss function, such as a binary cross-entropy loss function, determined based on the risk indicators generated by the PGCN 300 from the training predictor variables and the risk indicator labels.

The significance of a feature with respect to a given model can be evaluated by the extent that feature contributes to the model output relative to other input features. Significance can be understood under two interpretations—global significance and local significance. Global significance refers to the inherent manner in which a given model weights features relative to one another. That is, global significance represents whether the PGCN 300 has some inherent tendency to consider some features more important than others when making decisions, regardless of any particular case. On the other hand, local significance refers to instance-specific significance. That is, for a given decision, local significance indicates the relative weight of each feature in the case of that particular decision. As one example, for some feature vector with two elements A and B, while a model may in general assign equal global significance to each feature, if one of those features is missing for a given decision, the other feature will have 100% local significance in that particular case. So, in decisioning scenarios, global significance provides information about the nature of decisioning models in and of themselves independent of any particular input vector, and local significance provides information about particular decisions.

In the case of interpretable models, it should be possible to assess global significance from the model parameters with low computational complexity, and local significance should be assessable using model parameters and particular inputs. Using logistic regression, for example, it can be possible to understand global significance immediately and unequivocally from the model coefficients since features are combined linearly. It can also be possible to understand local significance easily, by taking the product of each model coefficient and the corresponding element of the relevant feature vector. As an example, consider a logistic regression model with three features, taking coefficients <0.2, 0.6, −0.8>. Here, the third feature is the most important globally, followed by the second. Then suppose some input vector is given by <1, 0.66, 0.25>. Multiplying the coefficients and the input vector element-wise results in <0.2, 0.4, −0.2>. For this particular case, the feature with the most significance locally is the second feature.

To make the significance interpretable, the network training application 112 may adjust the weights in the adjacency weight matrix W and the weights in the dense layer weights S under one or more constraints. While the outputs of the PGCN layer are interpretable as ‘the elements of the original input vector in the context of inter-feature interactions’, this may not be sufficient to render the dense weights as representative of the global significance of the input features. The reason for this insufficiency is that the dense weight corresponding to each feature may only be responsive to information that is received from other features. In cases where, for example, a feature receives a positive influence from some other feature, but imposes a negative influence on that feature, the received influence does not reflect imposed influence. As a result, some features may have a significantly negative impact on output Y through negative interaction effects on other features, but if the feature only receives positive interaction effects, the weight that corresponds to the feature in the dense layer 340 indicates that the feature has an overall positive influence on output Y, which is inaccurate.

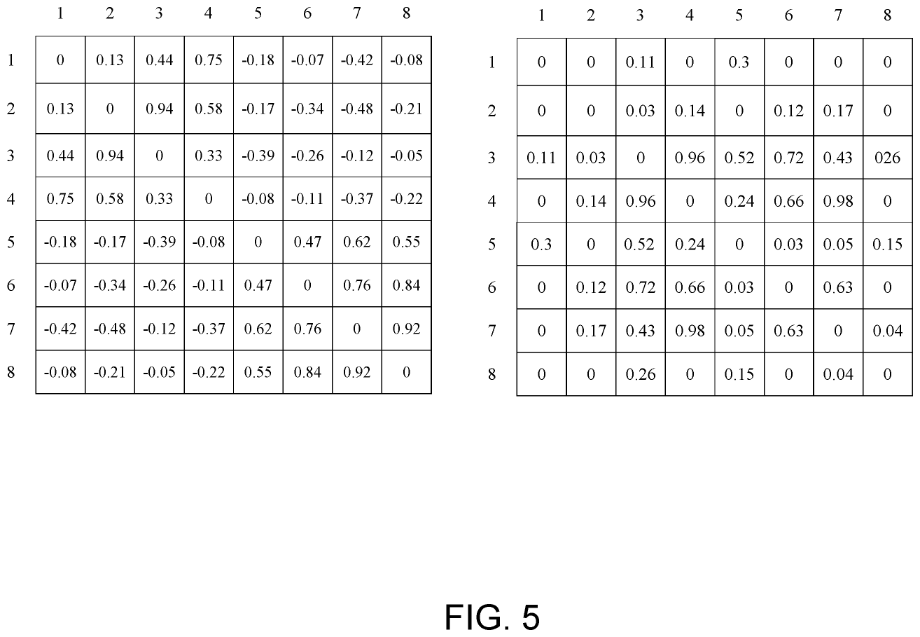

In some examples, the network training application 112 can impose a symmetry constraint on the adjacency weight matrix during training. The symmetry constraint can require the adjacency weight matrix to be a symmetric matrix. The symmetry constraint can preserve ‘interactive commutativity’, which represents that for two features A and B, the influence of A on B is equivalent to the influence of B on A. The adjacency weight matrices shown in FIG. 5 are both symmetric matrices.

Additionally, the network training application 112 can impose a positivity constraint on the adjacency weight matrix and the dense layer weights during training. The positivity constraint can constrain the weights such that features that are positively correlated with the risk indicator have positive weights in the dense layer 340 and can be mutually reinforcing (i.e. the interactions within this set of features will all be positive) and features that are negatively correlated with the risk indicator correspond to negative weights in the dense layer 340 (and also can be mutually reinforcing). Thus, introducing a positivity constraint may efficiently preclude the possibility of counter-intuitive scenarios (e.g., ‘days past due’ having a positive impact on credit score, etc.). Interactions between these two sets of ‘positive’ and ‘negative’ features are also constrained to be deflating. Under the positivity constraint, the model weights can be understood to represent global feature significance. Local significance can also be calculated using the weights together with input vectors.

A symmetry constraint and a positivity constraint imposed in this way can result in an adjacency weight matrix similar to the left adjacency weight matrix in FIG. 5. As illustrated, the adjacency weight matrix corresponds to eight features. Based on the symmetry constraint, the impact a first feature has on a second feature is the same as the impact the second feature has on the first feature. For example, feature 1 has an impact determined based on value 0.13 on feature 2, and feature 2 also has an impact determined based on value 0.13 on feature 1. Additionally, based on the positivity constraint, the first four features are positively correlated with the risk indicator, as indicated by positive weights, and the last four are negatively correlated with the risk indicator, as indicated by negative weights.

Supposing that the adjacency weight matrix is constrained in this way, it may be impossible for ‘positive’ features to have negative impacts on output Y, and vice versa. The effect of this may be that any changes in the input features that occur through graph convolution reflect both received and generated interaction effects, which establishes a conceptual basis for interpreting the dense layer weights as representative of overall input feature significance in the context of interactions. It may be noted that the magnitude of received and generated effects might differ in their significance with respect to model output due to differences in the magnitudes of the associated features. However, after a few convolutions, the magnitude of received interaction effects can be roughly proportional to that of generated effects. To understand the effect of the number of convolutions, the convolution process can be evaluated step by step.

As an example, consider a PGCN with two features, A and B. Under a symmetry constraint, the weights that control the interaction effect of A on B, and of B on A, are the same, and this value can be called w. The magnitudes of A and B can be different though (i.e. A and B may have different values when input into the adjacency weight matrix). At the first convolution, the effect of B on A, which corresponds to A's received interaction effect, is determined by w and the magnitude of B. That is, A changes according to w and B, and this change is representative of its received interaction effect. As the dense weight, s, corresponding to A is sensitive only to changes in A, the way that A changes also reflect A's generated interaction effects if s is to represent received and generated effects in a balanced way. But at the first convolution, this is not possible since the generated interaction effects of A, represented by the change of B with respect to A, are not yet captured in the change of A. Put differently, the way that A changes at the first convolution is dependent on pre-convolution B, and w, which entails that the way that A changes at the first convolution cannot reflect A's actual effect on B at the first convolution.

However, at the second convolution, A has already been affected once by B, and B by A. Accordingly, the received interaction effect of A at the second convolution, which depends on the magnitude of B after the first convolution, accordingly reflects the effects of A on B at the first convolution. In general, the received effects of A at convolution r reflect the generated effects of A at convolution r−1. Further, the total change of A through r convolutions encodes the generated effects of A up until convolution r−1. So, as r becomes larger, the proportion of total generated effects that are represented by the change of A increases (e.g., for r=1, it is 0/1, for r=2, it is 1/2, and for r=3 it is 2/3, etc.). Again, for each convolution, A will generate some effects, but only the generated effects from the previous convolution are captured in the change of A (and the growth of A is what the dense weight representing A's importance is sensitive to). So for ten convolutions, there are ten generated effects, but only nine of these are captured in A's change (thus the proportion captured is 9/10—which is much greater than 1/2 for the 2 convolution case). Thus, more convolutions lead to a better representation of the generated effects of A in the change of A itself.

Alternative or additional to the positivity constraint illustrated in the left matrix shown in FIG. 5, the network training application 112 may impose a global positivity constraint during training. To impose the global positivity constraint, the predictor variables can be pre-processed in the training samples to have a positive correlation with the risk indicator labels in the training samples. For example, the sign of the value of the predictor variable can be inverted if the predictor variable has a negative correlation with the risk indicator. Then, a global positivity constraint can be applied to the model parameters. The global positivity constraint can require that the weights in the adjacency weight matrix W and the weights in the dense layer weights S are positive.

The symmetry constraint and the global positivity constraint can result in an adjacency weight matrix similar to the right adjacency weight matrix in FIG. 5. As illustrated, the adjacency weight matrix includes eight features. Based on the symmetry constraint, the impact a first feature has on a second feature can be the same as the impact the second feature has on the first feature. For example, feature 5 has an impact determined based on value 0.15 on feature 8, and feature 8 has an impact determined based on value 0.15 on feature 5. Additionally, based on the global positivity constraint, all of the features are positively correlated with the risk indicator, as indicated by positive weights.

Applying either of the positivity constraints described can guarantee that feature values will change in a way that reflects not only the interaction effects that they receive, but also the interaction effects that they generate through a number of convolutions.

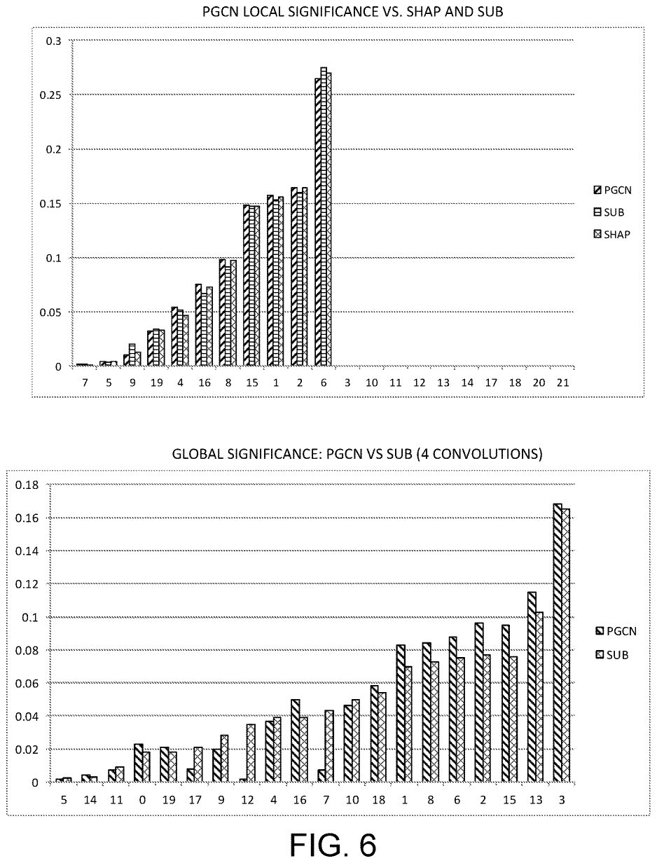

FIG. 6 shows examples of the global significance and the local significance of the predictor variables determined using the parameters of the power graph convolutional network in comparison with prior art post-hoc algorithms. The global significance and the local significance may be generated as explanatory data by the risk assessment application 114. The local significance can indicate an impact of at least some of the predictor variables on the risk indicator, and the global significance can indicate a relative impact of at least some of input predictor variables on an output risk indicator of the PGCN 300.

In the top example, the local significance of twenty predictor variables is shown, as determined by using the parameters the PGCN 300, Kernal SHAP (SHAP), and a SUB method which sets each feature to zero, one at a time, and measures the relative drop in model output. Nine of the predictor variables are shown to have zero local significance. The local significances determined for the other predictor variables from the PGCN 300 are similar to those determined by SHAP and SUB. As discussed above, the local significance of a predictor variable in PGCN 300 can be determined by multiplying the modified predictor variable output by the convolutional layer 330 with the corresponding dense layer weight. This local significance value is computed when generating the output Y. So, unlike the SHAP and SUB methods, there are no extra computations involved in determining the local significance for the PGCN.

In the bottom example of FIG. 6, the global significance of twenty predictor variables is shown, as determined by the PGCN 300 and SUB with four convolutions. The global significance values correspond to the weights in the dense layer weights S. As shown, the dense weights of the PGCN 300 provide a correct ordering of the top nine features. Again there are no extra computations involved in determining the global significance for the PGCN.

### Example of Computing System for Machine-Learning Operations

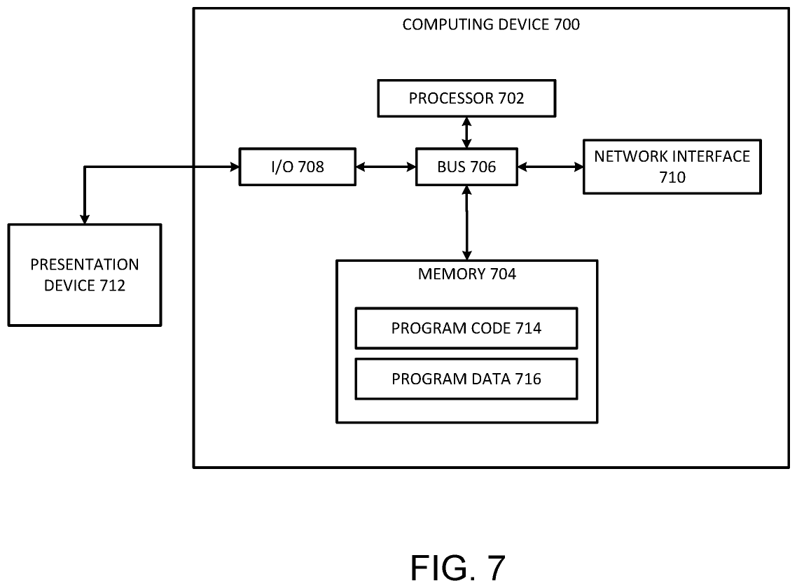

Any suitable computing system or group of computing systems can be used to perform the operations for the machine-learning operations described herein. For example, FIG. 7 is a block diagram depicting an example of a computing device 700, which can be used to implement the risk assessment server 118 or the network training server 110. The computing device 700 can include various devices for communicating with other devices in the operating environment 100, as described with respect to FIG. 1. The computing device 700 can include various devices for performing one or more transformation operations described above with respect to FIGS. 1-6.

The computing device 700 can include a processor 702 that is communicatively coupled to a memory 704. The processor 702 executes computer-executable program code stored in the memory 704, accesses information stored in the memory 704, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 702 include a microprocessor, an application-specific integrated circuit, a field-programmable gate array, or any other suitable processing device. The processor 702 can include any number of processing devices, including one. The processor 702 can include or communicate with a memory 704. The memory 704 stores program code that, when executed by the processor 702, causes the processor to perform the operations described in this disclosure.

The memory 704 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Python, Perl, JavaScript, ActionScript, etc.

The computing device 700 may also include a number of external or internal devices such as input or output devices. For example, the computing device 700 is shown with an input/output interface 708 that can receive input from input devices or provide output to output devices. A bus 706 can also be included in the computing device 700. The bus 706 can communicatively couple one or more components of the computing device 700.

The computing device 700 can execute program code 714 that includes the risk assessment application 114 and/or the network training application 112. The program code 714 for the risk assessment application 114 and/or the network training application 112 may be resident in any suitable computer-readable medium and may be executed on any suitable processing device. For example, as depicted in FIG. 7, the program code 714 for the risk assessment application 114 and/or the network training application 112 can reside in the memory 704 at the computing device 700 along with the program data 716 associated with the program code 714, such as the predictor variables 124 and/or the PGCN training samples 126. Executing the risk assessment application 114 or the network training application 112 can configure the processor 702 to perform the operations described herein.

In some aspects, the computing device 700 can include one or more output devices. One example of an output device is the network interface device 710 depicted in FIG. 7. A network interface device 710 can include any device or group of devices suitable for establishing a wired or wireless data connection to one or more data networks described herein. Non-limiting examples of the network interface device 710 include an Ethernet network adapter, a modem, etc.

Another example of an output device is the presentation device 712 depicted in FIG. 7. A presentation device 712 can include any device or group of devices suitable for providing visual, auditory, or other suitable sensory output. Non-limiting examples of the presentation device 712 include a touchscreen, a monitor, a speaker, a separate mobile computing device, etc. In some aspects, the presentation device 712 can include a remote client-computing device that communicates with the computing device 700 using one or more data networks described herein. In other aspects, the presentation device 712 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

1. A method that includes one or more processing devices performing operations comprising:
determining, using a power graph convolutional network trained by a training process, a risk indicator for a target entity from predictor variables associated with the target entity, wherein:
the power graph convolutional network comprises (a) a convolutional layer configured to apply an adjacency weight matrix on the predictor variables to generate modified predictor variables and (b) a dense layer configured to apply a weight vector on the modified predictor variables to generate the risk indicator, and
the training process comprises adjusting a first set of weights in the adjacency weight matrix and a second set of weights in the weight vector based on a loss function of the power graph convolutional network and under an explainability constraint on the first set of weights or the second set of weights of the power graph convolutional network; and
transmitting, to a remote computing device, a responsive message including at least the risk indicator for use in controlling access of the target entity to one or more interactive computing environments.

2. The method of claim 1, wherein the operations further comprise:
generating, for the target entity, explanatory data indicating impact of at least some of the predictor variables on the risk indicator.

3. The method of claim 1, wherein applying the adjacency weight matrix on the predictor variables comprises:
applying the adjacency weight matrix on the predictor variables to generate the modified predictor variables; and
applying the adjacency weight matrix on the modified predictor variables to update the modified predictor variables.

4. The method of claim 1, wherein the explainability constraint comprises a symmetry constraint requiring the adjacency weight matrix to be a symmetric matrix.

5. The method of claim 1, wherein the explainability constraint comprises a positivity constraint, the positivity constraint constraining the first set of weights and the second set of weights such that a first set of predictor variables positively correlated with the risk indicator correspond to positive weights in the second set of weights of the dense layer and a second set of predictor variables negatively correlated with the risk indicator correspond to negative weights in the second set of weights of the dense layer, the positivity constraint further requiring a weight in the first set of weights between a first predictor variable in the first set of predictor variables and a second predictor variable in the second set of predictor variables to be negative.

6. The method of claim 1, wherein the training process further comprises pre-processing predictor variables in training samples to have a positive correlation with risk indicator labels in the training samples, and wherein the explainability constraint comprises a global positivity constraint requiring the first set of weights and the second sets of weights are positive.

7. The method of claim 1, wherein the operations further comprise:
generating explanatory data comprising the second set of weights as an indication of relative impact of at least some of input predictor variables of the power graph convolutional network on an output risk indicator of the power graph convolutional network.

8. A system comprising:
a processing device; and
a memory device in which instructions executable by the processing device are stored for causing the processing device to:
determine, using a power graph convolutional network trained by a training process, a risk indicator for a target entity from predictor variables associated with the target entity, wherein:
the power graph convolutional network comprises (a) a convolutional layer configured to apply an adjacency weight matrix on the predictor variables to generate modified predictor variables and (b) a dense layer configured to apply a weight vector on the modified predictor variables to generate the risk indicator, and
the training process comprises adjusting a first set of weights in the adjacency weight matrix and a second set of weights in the weight vector based on a loss function of the power graph convolutional network and under an explainability constraint on the first set of weights or the second set of weights of the power graph convolutional network; and
transmit, to a remote computing device, a responsive message including at least the risk indicator for use in controlling access of the target entity to one or more interactive computing environments.

9. The system of claim 8, wherein further instructions executable by the processing device are stored for causing the processing device to:
generate, for the target entity, explanatory data indicating impact of at least some of the predictor variables on the risk indicator.

10. The system of claim 8, wherein the convolutional layer is configured to apply the adjacency weight matrix on the predictor variables by performing operations comprising:
applying the adjacency weight matrix on the predictor variables to generate the modified predictor variables; and
applying the adjacency weight matrix on the modified predictor variables to update the modified predictor variables.

11. The system of claim 8, wherein the explainability constraint comprises a symmetry constraint requiring the adjacency weight matrix to be a symmetric matrix.

12. The system of claim 8, wherein the explainability constraint comprises a positivity constraint, the positivity constraint constraining the first set of weights and the second set of weights such that a first set of predictor variables positively correlated with the risk indicator correspond to positive weights in the second set of weights of the dense layer and a second set of predictor variables negatively correlated with the risk indicator correspond to negative weights in the second set of weights of the dense layer, the positivity constraint further requiring a weight in the first set of weights between a first predictor variable in the first set of predictor variables and a second predictor variable in the second set of predictor variables to be negative.

13. The system of claim 8, wherein the training process further comprises pre-processing predictor variables in training samples to have a positive correlation with risk indicator labels in the training samples, and wherein the explainability constraint comprises a global positivity constraint requiring the first set of weights and the second sets of weights are positive.

14. The system of claim 8, wherein further instructions executable by the processing device are stored for causing the processing device to:
generate explanatory data comprising the second set of weights as an indication of relative impact of at least some of input predictor variables of the power graph convolutional network on an output risk indicator of the power graph convolutional network.

15. A non-transitory computer-readable storage medium having program code that is executable by a processor device to cause a computing device to perform operations, the operations comprising:
determining, using a power graph convolutional network trained by a training process, a risk indicator for a target entity from predictor variables associated with the target entity, wherein:
the power graph convolutional network comprises (a) a convolutional layer configured to apply an adjacency weight matrix on the predictor variables to generate modified predictor variables and (b) a dense layer configured to apply a weight vector on the modified predictor variables to generate the risk indicator, and
the training process comprises adjusting a first set of weights in the adjacency weight matrix and a second set of weights in the weight vector based on a loss function of the power graph convolutional network and under an explainability constraint on the first set of weights or the second set of weights of the power graph convolutional network; and
transmitting, to a remote computing device, a responsive message including at least the risk indicator for use in controlling access of the target entity to one or more interactive computing environments.

16. The non-transitory computer-readable storage medium of claim 15, wherein the operations further comprise:
generating, for the target entity, explanatory data indicating impact of at least some of the predictor variables on the risk indicator.

17. The non-transitory computer-readable storage medium of claim 15, wherein the convolutional layer is configured to apply the adjacency weight matrix on the predictor variables by performing operations comprising:
applying the adjacency weight matrix on the predictor variables to generate the modified predictor variables; and
applying the adjacency weight matrix on the modified predictor variables to update the modified predictor variables.

18. The non-transitory computer-readable storage medium of claim 15, wherein the explainability constraint comprises a symmetry constraint requiring the adjacency weight matrix to be a symmetric matrix.

19. The non-transitory computer-readable storage medium of claim 15, wherein the explainability constraint comprises a positivity constraint, the positivity constraint constraining the first set of weights and the second set of weights such that a first set of predictor variables positively correlated with the risk indicator correspond to positive weights in the second set of weights of the dense layer and a second set of predictor variables negatively correlated with the risk indicator correspond to negative weights in the second set of weights of the dense layer, the positivity constraint further requiring a weight in the first set of weights between a first predictor variable in the first set of predictor variables and a second predictor variable in the second set of predictor variables to be negative.

20. The non-transitory computer-readable storage medium of claim 15, wherein the training process further comprises pre-processing predictor variables in training samples to have a positive correlation with risk indicator labels in the training samples, and wherein the explainability constraint comprises a global positivity constraint requiring the first set of weights and the second sets of weights are positive.
